(19) United States
(12) Patent Application Publication
(10) Pub. No.: US 2005/0043976 A1
(43) Pub. Date: Feb. 24, 2005

(54) Method for improving business performance through analysis

(75) Inventor: Nathan Leehman, Simpsonville, SC (US)

Correspondence Address: BURNS DOANE SWECKER & MATHIS L L P, POST OFFICE BOX 1404, ALEXANDRIA, VA, 22313-1404, US

(73) Assignee: Michelin Recherche Et Technique S.A.

(21) Appl. No.: 10/643,340

(22) Filed: Aug. 19, 2003

(51) Int. Cl. G06F 17/60

(52) U.S. Cl. 705/7

(57) ABSTRACT

A method is described for improving business performance of a business entity. The method includes documenting one or more current business processes in an initial process map having one or more cost categories. Each current business process is categorized in each of the one or more cost categories that are cost dependent on the process. Each of one or more of the current business processes is compared with known business processes to determine whether one or more more cost effective business process is available for one or more respective current business processes. A recommended process map is created that includes a set of business processes that includes one or more recommended businesses processes by substituting, in the initial process map, one or more available more cost effective business processes for one or more respective current business processes.

### BACKGROUND

This application relates to systematic management of business processes. More particularly, the invention relates to categorizing, analyzing, and improving business processes through the use of key performance indicators and cost analysis.

As the trend toward globalization of business markets continues, business entities are under increasing pressure to reduce operating costs in order to stay competitive. Market pressures often require cost cutting beyond the conventional capabilities of many business entities. In many cases a business entity may exhaust raw material and labor related cost cutting measures only to fall short of their competitive goals. Market forces still leave the entity at a competitive disadvantage as a result of high operating costs.

In some cases, a business entity may even strive to optimize internal business processes to cut costs. These attempts will fail more often than not, not for lack of trying, but for lack of the tools needed to perform such an overhaul systematically. Due to conventional business hierarchy and practices, business entities often lack the knowledge to consider systematically the different processes of the business entity and the cost-related relationship between them.

Moreover, analyzing a single business process may not provide the information necessary to determine how best to optimize the process. One can usually determine easily whether the costs related to a particular process have decreased due to adjustments made to the process. The inquiry into whether those adjustments have resulted in an increase in costs related to one or more affected other processes is much more difficult. Even more problematic is how to determine when the process is optimized, i.e., when costs are minimized.

Another important consideration is the impact of the cost cutting measures on performance. Cost cutting measures that result in a reduction in performance below acceptable levels will often lead to an overall reduced level of competitiveness (or profit) for a business entity in the long run. Such undesirable results must be avoided through appropriate performance monitoring.

A need therefore exists for a method of improving business processes that overcomes these and other concerns.

### SUMMARY

It should be emphasized that the terms “comprises” and “comprising”, when used in this specification as well as the claims, are taken to specify the presence of stated features, steps, or components; but the use of these terms does not preclude the presence or addition of one or more other features, steps, components, or groups thereof.

In one aspect, a method for improving business performance of a business entity includes documenting one or more current business processes in an initial process map having one or more cost categories. Each current business process is categorized in each of the one or more cost categories that are cost dependent on the process. Each of one or more of the current business processes is compared with known business processes to determine whether one or more more cost effective business processes are available for one or more respective current business processes. A recommended process map is created that comprises a set of business processes that includes one or more recommended business processes by substituting, in the initial process map, one or more available more cost effective business processes for one or more respective current business processes. The recommended business processes are then implemented.

In another aspect, a method for developing a business process map includes documenting one or more current business processes in an initial process map having one or more cost categories. Each current business process is categorized in each of the one or more cost categories that are cost dependent on the process. Each of one or more of the current business processes are compared with known business processes to determine whether one or more more cost effective business processes are available for one or more respective current business processes. A recommended process map is created that includes a set of business processes that includes one or more recommended businesses processes by substituting, in the initial process map, one or more available more cost effective business processes for one or more respective current business processes. One or more corresponding key performance indicators are associated with each recommended business process in the recommended process map, the key performance indicators measuring process performance.

In yet another aspect, a business process map includes one or more cost categories and one or more business processes, wherein each business process is categorized in the one or more cost categories that are cost dependent on the process. The process map further includes one or more key performance indicators each associated with one or more of the business processes, the key performance indicators measuring process performance.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a business process map according to an aspect of the invention.

FIG. 2 is a flow chart illustrating a research phase according to an aspect of the invention.

FIGS. 3A and 3B are flow charts illustrating a maintenance phase according to an aspect of the invention.

FIGS. 4A and 4B are flow charts illustrating a continuous improvement phase according to an aspect of the invention.

FIGS. 5A and 5B together are a block diagram illustrating an exemplary detailed business process map for a trucking fleet business entity according to an aspect of the invention.

### DETAILED DESCRIPTION

Systematic management of business processes results in effective cost cutting. As discussed above, however, in order to succeed, process management cannot exclusively focus on a single problematic process, but must be performed with a broader view toward the effect on all processes, as well as the effect on the performance of the various processes.

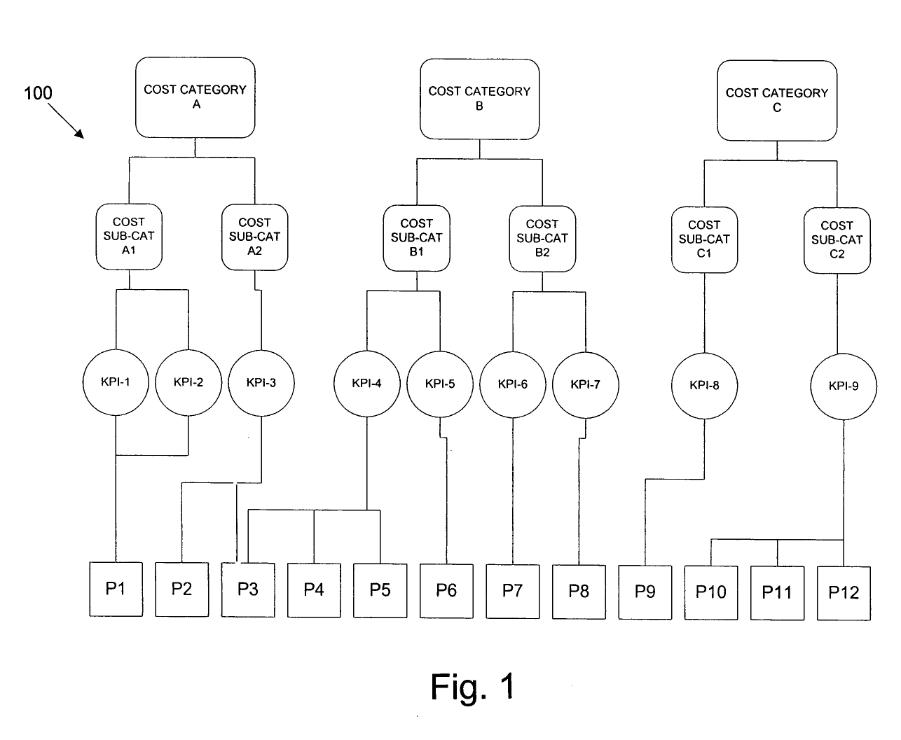

According to an aspect of the invention, a process map is developed to list, categorize, and interrelate the various processes of the business entity between each other and with their associated performance criteria. FIG. 1 is an exemplary process map 100. Twelve business processes, P1 through P12; nine key performance indicators (“KPI”), KPI-1 through KPI-9; six cost subcategories, A1, A2, B1, B2, C1, and C2; and three major cost categories, A, B, and C, are illustrated along with their relationships. The process map 100 serves as a tool for cost and performance related analysis associated with the various business processes of a business entity. Multiple KPIs can be associated with a single process, as is the case for P1. Inversely, a KPI may monitor multiple processes, as is the case with KPI-9. In practice, the process map 100 may comprise many more, or fewer, major cost categories, subcategories, KPIs, and/or processes. It should also be noted that cost subcategories are not required, but are used optionally to help further categorize the processes.

Examples of major cost categories A, B, and C, include the cost of service, products, shipping costs, and the like. Examples of cost subcategories A1, A2, B1, B2, C1, and C2, include the cost of labor, parts, maintenance, and the like. A business process is defined by a set of operating details that are used to carry out a specific business task. Examples of business processes, P1 through P12, include delivery process, inventory management, repairs, and the like. KPI-1 through KPI-9 are used to measure whether the corresponding business processes are operating in compliance with performance criteria established for the process. Examples of KPIs include inventory levels, total hours required, percent of product returns, and the like. For example, an inventory level KPI may be used to monitor an inventory management business process so that when inventory levels fall below a predetermined threshold, the KPI indicates noncompliance with the performance criteria for that business process.

For an additional example, assume that the business entity includes a shipping division with a fleet of trucks. Further assume that major cost category C is emergency road service for the trucks of the fleet. Cost subcategory C1 may be service, which would represent the accumulated cost of servicing the trucks when breakdowns occur. The associated business process, P9, is road service, which details the operations needed to perform emergency road service. The associated KPI, KPI-8, can be measured as downtime per service call. A threshold for KPI-8 can be, for example, four hours per incident. Unacceptable performance is indicated when KPI-8 is exceeded, i.e., when the average service call downtime exceeds four hours in this case.

Cost subcategory C2 may be preventative measures, such as inspections and routine maintenance. The associated business processes, P10-P12, may be vehicle inspection, routine maintenance, and product selection, respectively. The operations needed for each one of these processes are detailed in an operations manual. The associated KPI, KPI-9, for all of processes P10-P12 can be measured as number of service calls. A threshold for KPI-9 can be, for example, four calls per year. Unacceptable performance of one or more process is indicated when KPI-9 is exceeded, i.e., when four calls per year is exceeded.

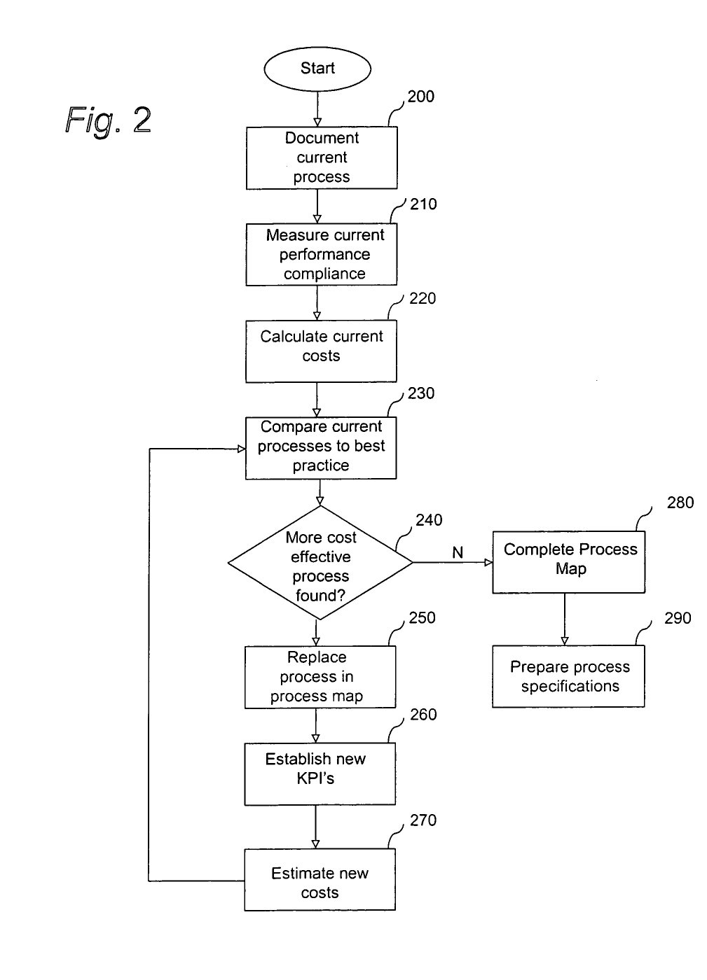

A method according to an aspect of the invention is illustrated in the flow chart of FIG. 2. During an initial research phase, a business entity's current business processes are documented and entered into the appropriate locations on the process map 100 (step 200). The entity's compliance with their current established performance standards is measured (step 210) using the performance criteria already established by the entity, if any exist. If the entity does not have established performance criteria, the level of compliance may be measured using established industry standards. One example of an industry standard is to maintain the tire pressure of all fleet truck tires in operation to be within 10 psi of a target air pressure. Costs are computed for each subcategory A1, A2, B1, B2, C1, and C2, and combined into the major cost categories A, B, and C to determine total cost (step 220).

Once the current processes are documented, each current process is compared to similar processes stored in an established “best practice” database (step 230). The best practice database comprises documented (either in electronic format or on paper) proven processes. The current processes are compared to a corresponding best practice process to determine which process will be most cost effective while meeting performance criteria (step 240). If a replacement process is selected from the best process database, the new process is substituted into the process map 100 (step 250).

The new process may optionally be tailored to the individual needs of the business entity by considering existing “situational factors” and adjusting for overall business entity guidelines. For example, fleet truck tires that are slated for repair may be handled differently depending on the remaining life of the tire, (e.g., tread depth and uniformity), which is a situational factor. KPIs are established that fit the new process (step 260), including recommended compliance levels and audit guidelines. The new costs associated with each new process are estimated (step 270) based on cost analysis performed using all available information, including information contained in the best practice database.

For example, when a new process is identified, costs can be quantified as external direct costs, (e.g., anticipated bills from outside vendors of machinery and services necessary to implement process change); internal direct costs, (e.g., cost of labor required to implement and manage process change); and indirect costs, (e.g., cost of administration and management labor necessary to implement and manage process change).

The one time implementation and repetitive operations costs associated with the implementation and management of the process change as detailed above are typically quantified over a specified period (e.g., 3-5 years), and use “Net Present Value” techniques to establish the current value of the proposed process change. In the event that this value is positive, the process change is implemented. In the event that a negative Net Present Value is returned, the proposed process is rejected.

The updated subcategory and major category costs are calculated. This procedure is repeated for each process until the most cost effective process map 100 is prepared (step 280). Specifications are prepared (step 290), such as manuals, to document the operating details of each process of the process map 100.

Thus far, new processes have been documented but not yet implemented, i.e., have not been put into practice at the business entity. During a start-up phase, the new processes may be incrementally introduced and put into use at the business entity. The operational specifications for each business process are followed. In order to accelerate the cost savings impact, the new processes may optionally be divided into categories according to cost savings impact. For example, processes resulting in the greatest savings (i.e., above a predetermined savings threshold) would all be placed in savings category 1, processes resulting in less savings (i.e., above a lower savings threshold) would all be placed in savings category 2, and so on. The new processes in savings category 1 would be introduced first, then those in savings category 2, and so on. The KPIs related to the new processes are implemented and monitored as each new process is introduced to measure process performance compliance.

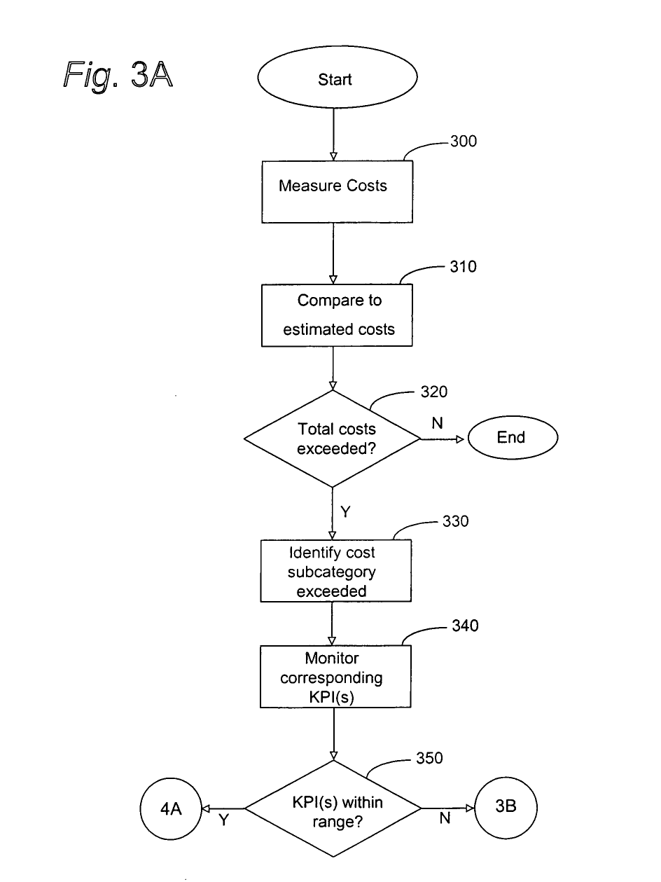

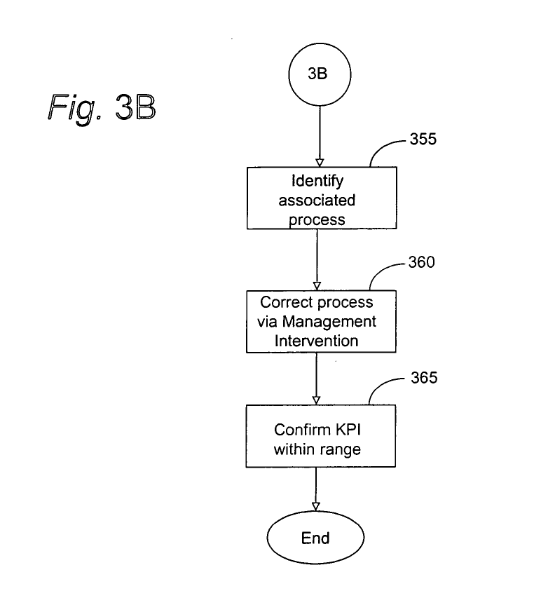

Once all new processes are implemented at the business entity, all processes are maintained during a maintenance phase, which is illustrated in FIGS. 3A and 3B. Actual costs are measured (step 300), preferably periodically (e.g., weekly, monthly, or annually), at the major cost category level and compared (310) to the costs that were estimated using the process map 100. When an estimated cost is exceeded (step 320) in a major cost category, the subcategory costs in that category are analyzed to determine which specific costs are exceeding estimates (step 330). If more than one subcategory is missing its estimated cost budget, the category with the highest cost variance is addressed first.

Once a problematic cost subcategory has been identified, the KPIs associated with the cost subcategory are monitored (step 340). KPIs that are found to be outside of their acceptable performance range (step 350) are traced to their associated process or processes (step 355) using the process map 100. Using the example above, when KPI-9 indicates that the threshold four service calls per year has been exceeded, the associated business processes, P10-P12, i.e., vehicle inspection, routine maintenance, and product selection are implicated. The implicated process or processes are systematically addressed, e.g., through intervention of management personnel, until they are operating according to the documented operating specifications developed during the research phase (step 360). Once a corresponding process is corrected to operate within operating specifications, the associated KPI is monitored again to confirm that the performance level is at an acceptable level (step 365). Where a KPI is associated with a single process, for example, as KPI-8 monitors P9 in FIG. 1, the focus remains on the single process until the performance is within parameters. When a KPI is associated with two or more processes, for example, as KPI-9 monitors P10-P12 in FIG. 1, each subsequent process is addressed and the KPI is subsequently monitored until the performance is within parameters.

The shipping division example above is used below to illustrate the maintenance phase. When the budget for emergency road service (major cost category C) is exceeded, cost subcategories C1 and C2 are reviewed to determine in which subcategory the problem lays. If the preventative measures subcategory (cost subcategory C2) is over cost budget, KPI-9 is monitored to determine whether P10-P12 are operating within the acceptable performance range. If KPI-9 is outside the acceptable range, P10-P12 are monitored closely to determine which process or processes are causing the additional costs.

When all corresponding processes are operating according to specification and within KPI performance parameters, the subcategory cost is monitored to determine cost budget compliance. Once all subcategory costs are within associated cost budget targets, the major categories will be within cost budget as well. The business entity has now been transformed to operate according to the best known practices. With only periodical monitoring and adjustment, the operation of the entity can be maintained accordingly.

Alternatively, however, if all the KPIs are in an acceptable range (step 350) and the subcategory costs are not within associated cost budgets, a continuous improvement phase may be initiated (discussed further below). Even when the subcategory costs are within associated cost budgets, knowledge about new and improved processes is preferably considered as it becomes available.

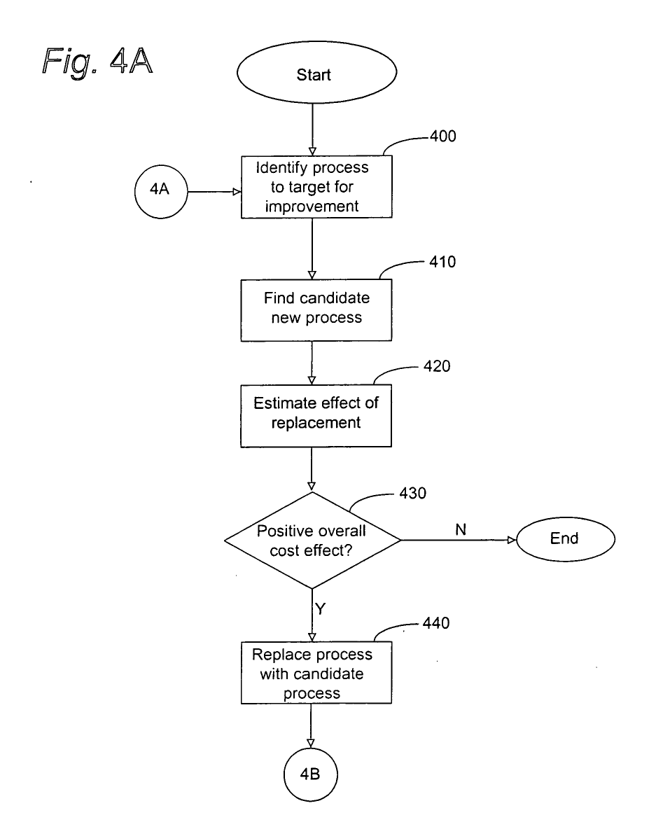

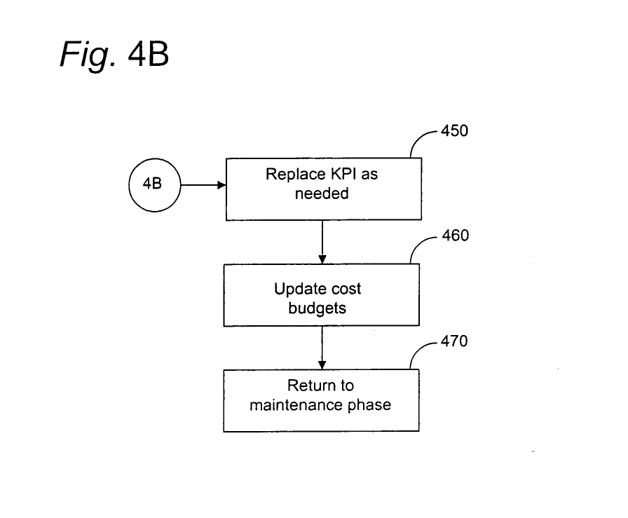

The continuous improvement phase is illustrated in the flow chart of FIGS. 4A and 4B. During the continuous improvement phase, processes are improved or replaced. The process map 100 is used to help identify the specific subcategories, KPIs, and ultimately processes to target for improvement (step 400). Processes requiring improvement may be prioritized from greatest to least cost impact.

The target processes are compared to the latest available process information obtained from the best practice database, or from other sources. Once a candidate new process is discovered (step 410), the process map 100 is used to estimate the overall effect of the process replacement (step 420). A complete return on investment (ROI) analysis is performed with the candidate process in the process map 100 and taking into account all foreseeable expenses that may be impacted by the change. The candidate process is adopted only if implementing the candidate process will result in a positive overall effect (i.e., reduced costs and/or improved performance without additional cost) (step 430). If a positive overall effect is estimated, the existing process is replaced with the candidate process (step 440).

Once a candidate process is adopted, the corresponding KPI is reviewed and, as needed, a new KPI is established to best measure the process' success (step 450). The cost budgets are updated in the corresponding subcategories and major categories (step 460). The new process is then implemented and maintained as described in the maintenance phase above.

The continuous improvement phase may be continued indefinitely, as the name suggests. The KPIs and costs are reviewed and processes are improved and replaced as needed. Successful processes are added to the best practice database for future use.

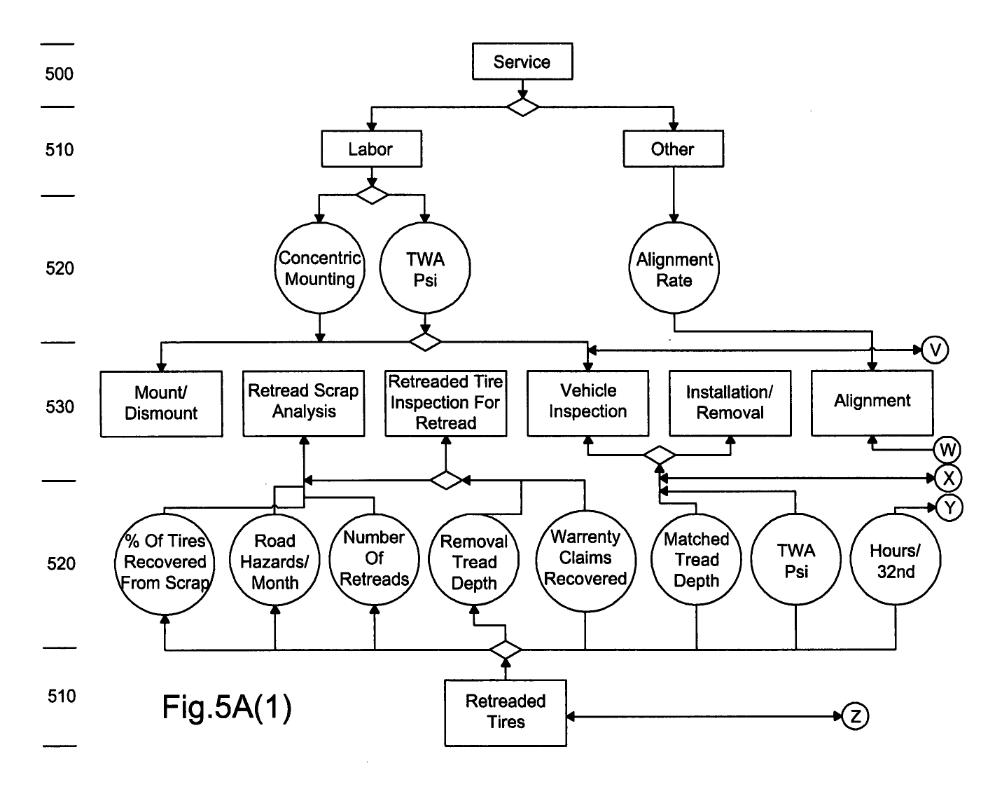

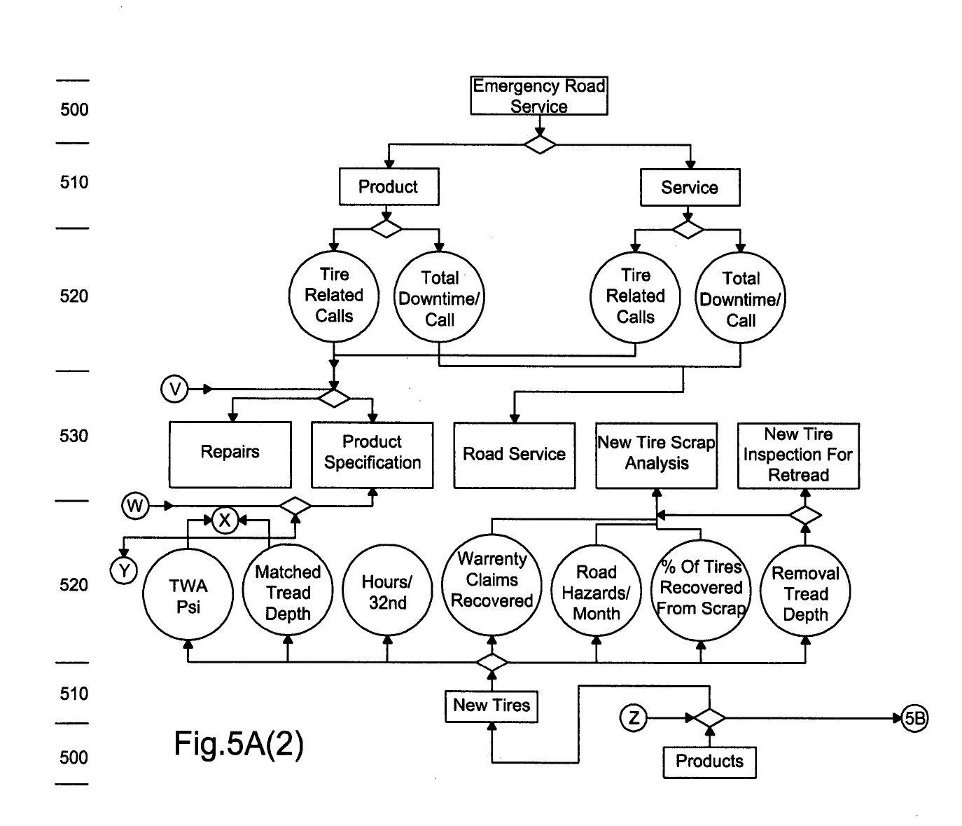

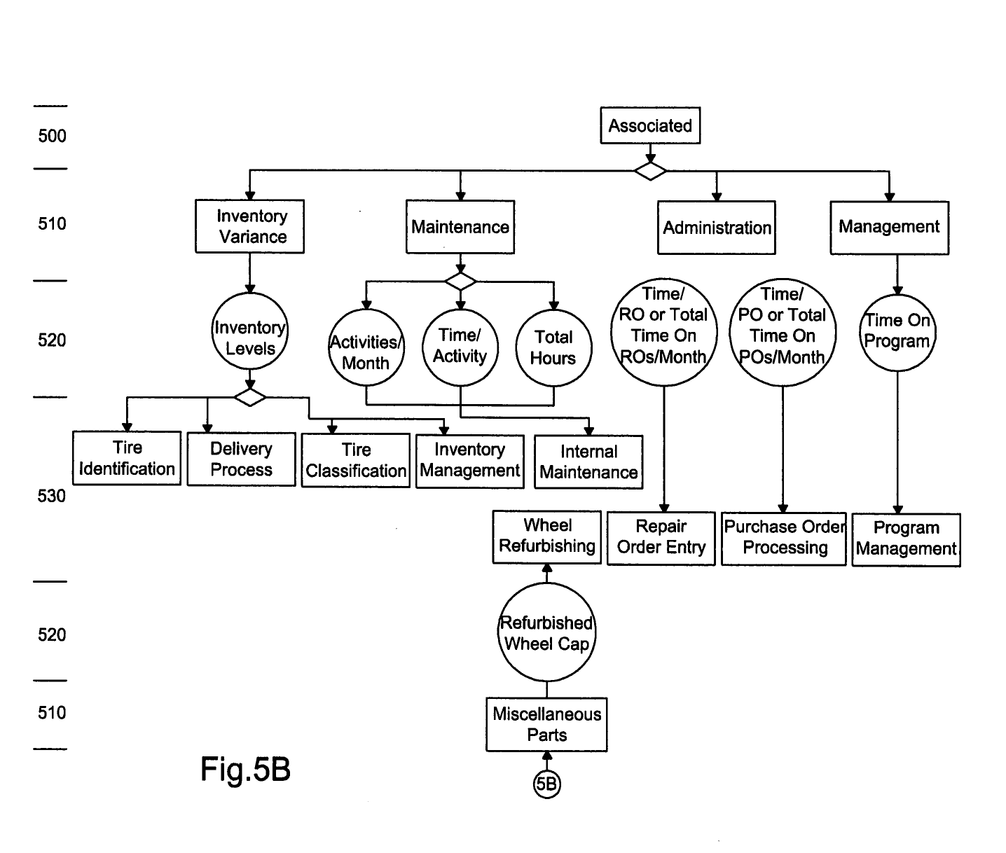

FIGS. 5A and 5B are a block diagram illustrating an exemplary business process map for a trucking fleet business entity according to an aspect of the invention. The process map includes four major cost categories, 500, and the associated cost subcategories 510, KPIs 520, and business processes 530. A brief description of each term appears below.

Major Cost Categories 500:

Service: Labor, miscellaneous parts and tools supplied by an outside vendor for use in the normal course of a fleet's tire program implementation and management.

Emergence Road Service: Product, labor, miscellaneous parts, and tools, which are supplied either internally or externally to address nonstandard tire program needs. Generally considered to include unplanned purchases due to accident, damage or neglect in a manner that cannot be anticipated or planned for in the normal course of a fleet's tire program implementation and management.

Products: Major parts necessary to ensure the continued mobility of a fleet as it relates to the normal or planned aspects of tire program management.

Associated: Labor and capital costs supplied via internal labor or resources, to include capital costs related to tire program management

Cost Sub-Categories 510:

Labor: Labor supplied by an outside vendor for use in the normal course of a fleet's tire program implementation and management.

Other: Miscellaneous parts and tools supplied by an outside vendor for use in the normal course of a fleet's tire program implementation and management.

Product: New tires, retreaded tires, and major miscellaneous parts, which are supplied either internally or externally to address nonstandard tire program needs. Generally considered to include unplanned purchases due to accident, damage or neglect in a manner that cannot be anticipated or planned for in the normal course of a fleet's tire program implementation and management.

Service: Labor, miscellaneous parts, and tools, which are supplied either internally or externally to address nonstandard tire program needs. Generally considered to include unplanned purchases due to accident, damage or neglect in a manner that cannot be anticipated or planned for in the normal course of a fleet's tire program implementation and management.

New Tires: Tires as originally sold by the manufacturer necessary to ensure the continued mobility of a fleet as it relates to the normal or planned aspects of tire program management.

Retreaded Tires: Tire casings that have been subject to a manufacturing process that replaces the worn tread surface of a tire with additional rubber (molded in a specific tread pattern) in an effort to extend the overall life of the product. Category includes all tires that have gone through this process and are purchased in an effort to ensure the continued mobility of a fleet as it relates to the normal or planned aspects of tire program management.

Miscellaneous Parts: Complementary parts (such as wheels, automatic air inflation systems, and more) supplied in an effort to ensure the continued mobility of a fleet as it relates to the normal or planned aspects of tire program management.

Inventory Variance: The capital and financing charges that a company absorbs due to carrying an inventory of products and parts associated with the normal management of a tire program.

Maintenance: The cost of labor supplied via internal staffing dedicated to the overall upkeep of a tire management program, to include non-dedicated resources involved in the normal supply of labor to the fleet.

Administration: The cost of labor supplied via internal staffing dedicated to information capture and analysis, to include data entry and reporting.

Management: The cost of labor supplied via internal staffing dedicated to the supervision and decision making function of the tire management program.

Key Performance Indicators 520:

Concentric Mounting: A measurement of the ability of a tire to be placed on the wheel in a manner that allows no variation in the distance from the bead area to the wheel flange.

Tire Wheel Assembly (TWA) Psi: A measurement of the air pressure of a tire mounted on a wheel assembly.

Alignment Rate: A measurement of the ratio of units in a given fleet to the quantity of full or partial alignments performed.

Tire Related Calls: A measurement of the quantity of Emergency Road Service calls initiated by the fleet in an effort to address an unscheduled service need.

Total Downtime Per Call: A measurement of the total time involved in the task of addressing an Emergency Road Service call. Generally measured from the time an ERS call is initiated to the time the vehicle is able to resume its previous task.

Inventory Levels: A measurement of the total quantity and value of all product held in inventory at a given time.

Activities Per Month: A measurement of the quantity of single activities completed per month by a person or persons performing a maintenance function.

Time Per Activity: A measurement of the total time involved in the task of completing a specific activity or group of activities, which is generally measured from the time a maintenance task is initiated until the time a similar or unique activity is initiated.

Total Hours: A measurement of the total time involved in the coordination and completion of maintenance duties over a given period of time. This measurement may be comprised solely of the total number of unique activities multiplied by the total time per activity or via a running calculation of the total time input by the maintenance resource or resources.

Time Per Repair Order (RO)/Purchase Order (PO): A measurement of the total time involved in the task of completing a single Repair Order/Purchase Order or group of Repair Orders/Purchase Orders. Generally measured from the time the task or tasks are initiated until the time that task or tasks are completed.

Total Time on Repair Orders/Purchase Orders Per Month: A measurement of the total time involved in the coordination and completion of Repair Orders/Purchase Orders over a month long period of time. This measurement may be comprised solely of the total number of unique activities multiplied by the total time per activity or via a running calculation of the total time input by the administrative resource or resources.

Percent of Tires Recovered From Scrap: A measurement of the ratio of the tires designated as scrap by a servicing manager and the tires that are identified as non-scrap by a qualified judge.

Road Hazards Per Month: A measurement of the number of tires damaged or destroyed while operating on a vehicle during the course of business. These damages may be found either while operating or during an inspection process generally associated with the retreading process.

Number of Retreads: A measurement of the quantity of tires delivered that have undergone the tire retreading process

Removal Tread Depth: A measurement of the tread depth remaining on new and retreaded product removed from fleet vehicles.

Warranty Claims Recovered: A measurement of the monetary value of all reimbursements due to poor quality, inferior workmanship, or commercial concessions on new and retreaded tire products.

Matched Tread Depth: A measurement of the variance in total tread depth between two new or retreaded tires matched in “dual” positions on a vehicle. May also apply to the variance in total tread depth between two sets of “dual” mounted tires across the same axle on a vehicle.

Hours Per 32^{nd} (Miles Per 32^{nd}, etc): A measurement of the performance delivered by a tire derived by comparing the difference between total tread depth at the beginning of a period and the end of a period with the total hours (miles) run by said tire over the same period.

Refurbished Wheel Cap: A measurement of the total number of wheels submitted and delivered for refinishing, to include inspection, sandblasting, paint or powdercoat finishes, and certification of safe operation.

Processes 530:

Mount/Dismount: A description of the process involved in mounting and/or dismounting a loose tire or tires from a wheel or wheels.

New Tire/Retread Scrap Analysis: A description of the process involved in determining the removal causes for tires that have been damaged beyond repair or reuse.

New Tire/Retreaded Tire Inspection For Retread: A description of the process involved in determining a tire's eligibility for the retreading process

Vehicle Inspection: A description of the process involved in inspecting the tires on a vehicle or set of vehicles for critical wear and use issues (including tread depth, air pressure, and more).

Installation/Removal: A description of the process involved in the installation or removal of a tire wheel assembly from a fleet vehicle.

Alignment: A description of the process involved in measuring and repairing deficiencies in the thrust angle or axle skew of fleet vehicles.

Repairs: A description of the process involved in returning a damaged tire or tires to their previous operational condition.

Product Specification: A description of the process involved in identifying the proper tires and retreads for the specific fleet application and vehicle type.

Road Service: A description of the process involved in implementing and managing a system for the emergency deployment of resources involved with unexpected mechanical or product failures outside the fleet terminal.

Tire Identification: A description of the process involved in tracking specific assets regardless of their physical location.

Delivery Process: A description of the process involved in receiving products from an outside vendor and expelling products from the fleet inventory.

Tire Classification: A description of the process involved in identifying and sorting product.

Inventory Management: A description of the process involved in organizing the products in a manner that provides the most effective means of accessing the product in the future in a cost effective manner.

Wheel Refurbishing: A description of the process involved in product refinishing, to include inspection, sandblasting, paint or powdercoat finishes, and certification of safe operation.

Repair Order Entry: A description of the process involved in the data capture of all work performed, as well as the assignment of costs to the proper business unit or segment.

Purchase Order Processing: A description of the process involved in creating and managing the billing process involved in maintaining a tire program.

Program Management: A description of the process involved in coordinating all aspects of a tire program.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for improving business performance of a business entity, comprising:
documenting one or more current business processes in an initial process map having one or more cost categories, wherein each current business process is categorized in each of the one or more cost categories that are cost dependent on the process;
comparing each of one or more of the current business processes with known business processes to determine whether one or more more cost effective business processes are available for one or more respective current business processes; and
creating a recommended process map comprising a set of business processes including one or more recommended business processes by substituting, in the initial process map, one or more available more cost effective business processes for one or more respective current business processes.

2. The method of claim 1, further comprising:
implementing the recommended business processes.

3. The method of claim 1, wherein creating a recommended process map further comprises:
establishing one or more corresponding key performance indicators in association with each recommended business process, said key performance indicators measuring process performance.

4. The method of claim 3, wherein creating a recommended process map further comprises:
estimating, by cost category, costs associated with each business process; and
determining a cost budget per cost category according to the estimated costs.

5. The method of claim 4, further comprising:
measuring the actual costs of the business processes in operation; and
comparing the actual costs with the estimated costs to determine whether one or more of the cost budgets are exceeded.

6. The method of claim 5, further comprising:
when a cost category's budget is exceeded, determining, based on associated key performance indicators, whether any business processes in the category are performing outside an acceptable range; and
correcting any business processes that are performing outside the acceptable range.

7. The method of claim 6, further comprising:
identifying a business process to target for replacement with a new candidate process;
estimating, using the recommended process map, an overall cost effect of replacing the targeted business process with the new candidate process; and
replacing the business process with the new candidate process when the overall cost effect indicates a reduced cost.

8. The method of claim 7, further comprising:
establishing one or more new corresponding key performance indicators for the new candidate process; and
determining a new cost budget for the cost category of the new candidate process.

9. The method of claim 2, wherein implementing the recommended business processes comprises:
categorizing the recommended business processes into a plurality of cost savings categories according to potential cost savings; and
implementing those business processes in a category providing the most cost savings first.

10. The method of claim 1, wherein the cost categories include one or more of service costs, product costs, and shipping costs.

11. The method of claim 1, wherein the recommended business processes include one or more of delivery processes, inventory management, and repairs.

12. A method for developing a business process map, comprising:
documenting one or more current business processes in an initial process map having one or more cost categories, wherein each current business process is categorized in each of the one or more cost categories that are cost dependent on the process;
comparing each of one or more of the current business processes with known business processes to determine whether one or more more cost effective business processes are available for one or more respective current business processes;
creating a recommended process map comprising a set of business processes including one or more recommended businesses processes by substituting, in the initial process map, one or more available more cost effective business processes for one or more respective current business processes; and
associating one or more corresponding key performance indicators with each recommended business process in the recommended process map, said key performance indicators measuring process performance.

13. The method of claim 12, wherein the cost categories include one or more of service costs, product costs, and shipping costs.

14. The method of claim 12, wherein the recommended business processes include one or more of delivery processes, inventory management, and repairs.

15. A business process map, comprising:
one or more cost categories;
one or more business processes, wherein each current business process is categorized in each of the one or more cost categories that are cost dependent on the process; and
one or more key performance indicators each associated with one or more of the business processes, said key performance indicators measuring process performance.
